(19) United States
(12) Patent Application Publication
(10) Pub. No.: US 2025/0388447 A1
(43) Pub. Date: Dec. 25, 2025

(54) BOTTLE OPENER

(71) Applicant: B/E Aerospace, Inc., Winston Salem, NC (US)

(72) Inventors: Jo-Ann Canja Perez, Calamba (PH); Jezzel Rayner Villena Perez, Calamba City (PH); Alyssa Yvonne Valentos Alipis, Makati (PH)

(73) Assignee: B/E Aerospace, Inc., Winston Salem, NC (US)

(21) Appl. No.: 19/236,664

(22) Filed: Jun. 12, 2025

(30) Foreign Application Priority Data
Jun. 24, 2024 (EP) 24184112

(51) Int. Cl. B67B 7/16

(52) U.S. Cl. CPC B67B 7/16

(57) ABSTRACT

A bottle opener comprising a first member and a limiting member is disclosed. The first member is configured to be pivotably mounted adjacent a first end thereof relative to a surface. The bottle opener has a default use position in which the first member extends at an angle (A) to the surface and a stowed position in which the first member extends flush with the surface. The limiting member is configured to limit the extent to which the first member can pivot relative to the surface. The first member comprises an edge that is configured to receive an remove a bottle cap from a bottle.

### CROSS-REFERENCE TO RELATED APPLICATIONS

This application claims priority to EP patent application Ser. No. 24/184,112.1, filed Jun. 24, 2024 and titled “BOTTLE OPENER,” which is incorporated by reference herein in its entirety for all purposes.

### FIELD

The present disclosure relates to bottle openers such as, for example, bottle openers for use in aircraft galleys.

### BACKGROUND

The present disclosure relates to bottle openers, for example bottle openers for mounting to a wall or panel in, for example, aircraft galleys, aircraft galley compartments, and/or aircraft galley inserts (GAINs). Such aircraft galleys, aircraft galley compartments, GAINs and bottle openers may be used in commercial aircraft.

As the galley in a commercial aircraft is used frequently during its operational life, it is important to minimize the amount of time required to maintain and repair equipment used within the galley. There is therefore a need to improve or increase the durability of equipment in the galley.

In addition, space is limited in an aircraft, therefore there is a need to maximize or increase the amount of usable space in the galley.

Bottle openers in aircraft galleys can be attached to a wall or panel adjacent to a GAIN for convenience. Such bottle openers are rigid structures that protrude from the surface they are mounted to. Such bottle openers can lead to damage being caused to GAINs. For example, they may cause damage to a door of a GAIN that they are adjacent to as the door may collide with the rigid bottle opener when the door is opened. Thus, there is a need to produce a bottle opener for an aircraft galley that maintains its functionality while minimizing the damage caused to other nearby equipment and maximizing its space efficiency.

### SUMMARY

According to a first aspect of this disclosure, there is provided a bottle opener for mounting to a surface, comprising: a first member having a first end and a second end opposite the first end, the first end being configured to be pivotably mounted adjacent the first end thereof relative to a surface, the bottle opener having a default use position in which the first member extends outwardly at an angle to the surface and a stowed position in which the first member extends substantially parallel to the surface; and a limiting member configured to limit the extent to which the first member can pivot relative to the surface, an edge formed in the first member configured to receive and remove a bottle cap from a bottle.

In any example of the disclosure, the limiting member may be configured to limit the extent to which the first member can pivot relative to the surface such that the second end of the first member is higher than the first end of the first member in a vertical direction when in the default use position and when in the stowed position.

In any example of the disclosure, the bottle opener may comprise a biasing means that biases the first member into the default use position.

In any example of the disclosure, the bottle opener may be configured to move into the stowed orientation in response to a force acting against the biasing means being applied thereto.

In any example of the disclosure, the limiting member may be connected to the first member.

In any example of the disclosure, the limiting member may be configured to be pivotably mounted relative to the surface.

In any example of the disclosure, the limiting member may be configured to be mounted relative to the surface such that it can translate parallel to the surface.

In any example of the disclosure, the bottle opener may further comprise a bumper mounted adjacent to the second end of the first member.

In any example of the disclosure, in response to a force being applied to the bottle opener in a direction towards and substantially perpendicular to the surface, the first member may be configured to pivot towards the surface, and the limiting member may be configured to pivot towards the surface, and the second end of the limiting member may be configured to translate substantially parallel to the surface, optionally substantially upwards in a vertical direction.

In any example of the disclosure, the bottle opener may comprise a support structure configured to be mounted to the surface.

In any example of the disclosure, the first member and the limiting member may both be pivotably mounted to the support structure.

In any example of the disclosure, the support structure may comprise one or more slots configured to receive a sliding pin, the limiting member may be connected to the support structure by the sliding pin, and the sliding pin may be configured to be disposed in the one or more slots such that the sliding pin can translate substantially parallel to the surface.

In any example of the disclosure, the support structure may comprise a stop configured to limit the extent to which the first member can pivot relative to the surface.

In any example of the disclosure, the bottle opener may comprise a bottle cap rest that is fixed relative to the surface, the bottle cap rest being configured to be used with the edge to remove the bottle cap from the bottle.

In any example of the disclosure, the first member may comprise one or more legs extending from the first end towards the second end, an opening is defined by the legs and by the edge, the opening being configured to receive the bottle.

According to a further aspect of this disclosure, there is provided a bottle opener, comprising: a first member having a first end, the first member being configured to be mounted adjacent the first end thereof relative to a surface, the first member being mounted at an angle to the surface, the first member comprising: an edge configured to receive and remove a bottle cap from a bottle; a second end, opposite the first end; and a bumper adjacent to the second end of the first member, the bumper being disposed further from the surface in a direction normal to the surface than the first member, the bumper being free to rotate relative to the first member.

### BRIEF DESCRIPTION OF THE DRAWINGS

FIGS. 1a and 1b are schematic perspective views of a bottle opener according to an example of the disclosure attached to a panel in an aircraft galley;

FIGS. 2a and 2b are schematic perspective views of a bottle opener according to an example of the disclosure attached to a panel in an aircraft galley;

FIG. 3 is a schematic side view of a bottle opener according to an example of the disclosure;

FIG. 4 is a schematic front view of a bottle opener according to an example of the disclosure;

FIG. 5 is a schematic side view of a bottle opener according to an example of the disclosure;

FIG. 6 is a schematic front view of a bottle opener according to an example of the disclosure;

FIG. 7 is an exploded view of a bottle opener according to an example of the disclosure; and

FIG. 8 is a schematic side view of a bottle opener according to an example of the disclosure being used to remove a bottle cap from a bottle.

### DETAILED DESCRIPTION

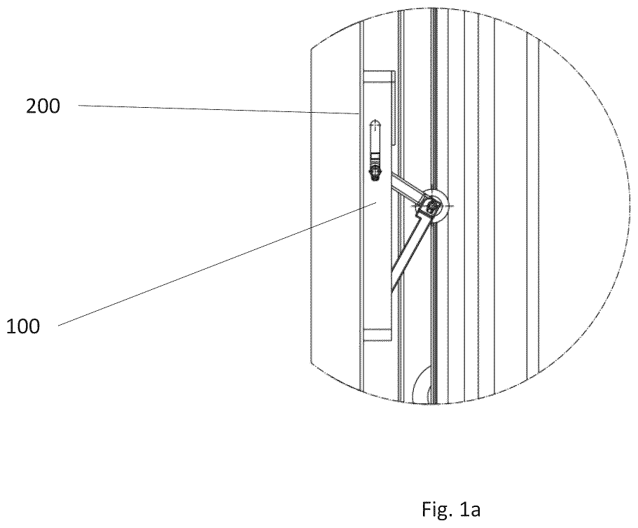

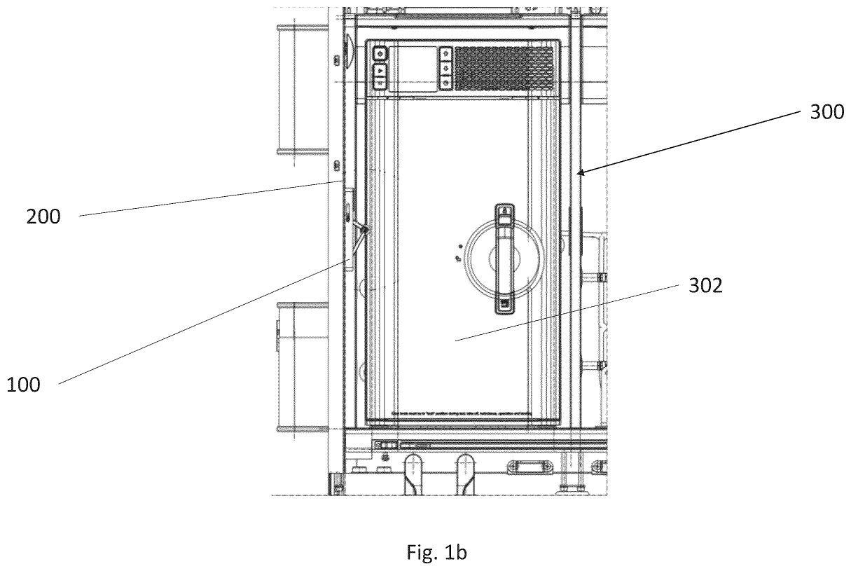

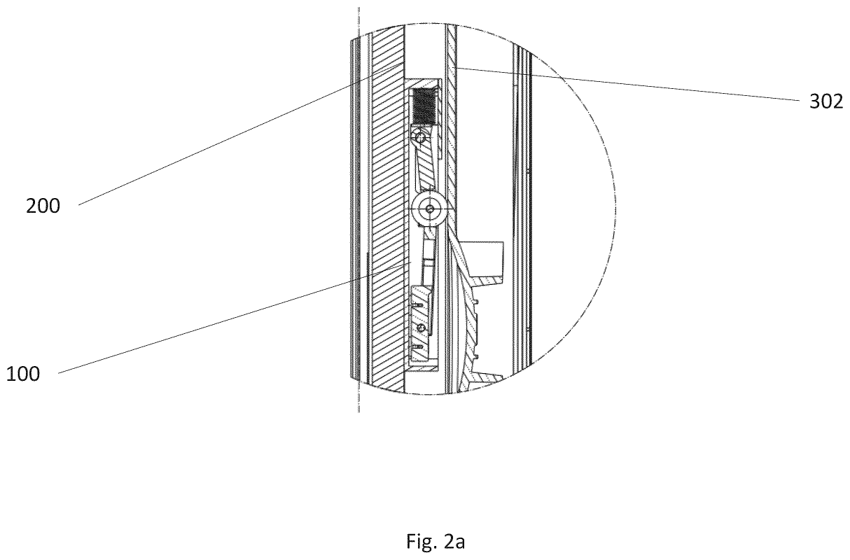

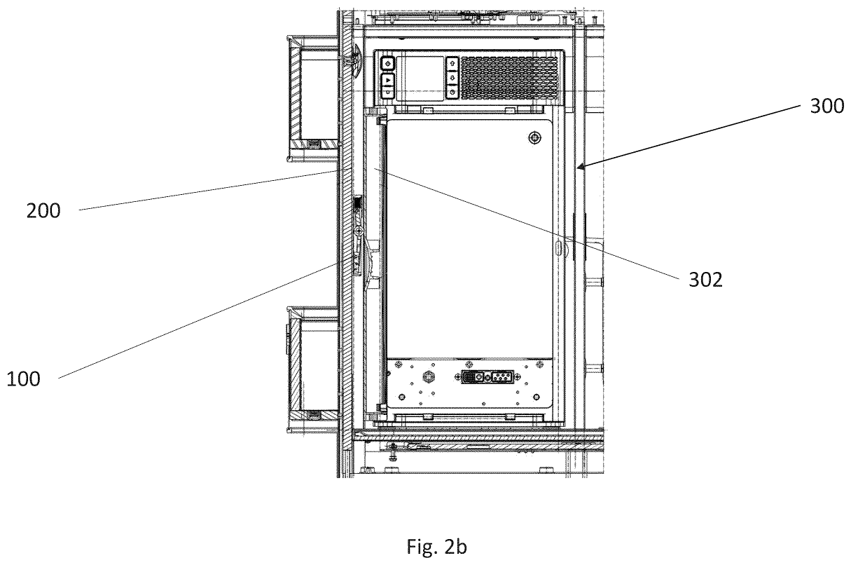

FIGS. 1a and 2a show perspective views of a bottle opener 100 in accordance with an example of the disclosure in respective default use and stowed positions as will be described further below. The bottle opener 100 may be configured to be mounted to a surface 200. The surface 200 may be a substantially vertical surface defining a vertical direction 201. The vertical direction 201 may be parallel with the surface 200. The surface 200 may be, but is not limited to, any of a wall, a panel, a hinged panel, and a door. The substantially vertical surface may be disposed in an aircraft galley.

FIGS. 1b and 2b show wider perspective views of the views seen in FIGS. 1a and 2a. In FIG. 1b, a Galley Insert (GAIN) 300 comprising a GAIN door 302 can be seen along with the bottle opener 100, the bottle opener 100 being mounted to the surface 200 as in FIG. 1a. The GAIN door 302 is in a closed position and, when in the closed position, extends at approximately 90 degrees to the surface 200 on which the bottle opener 100 is mounted. The GAIN door 302 is hinged at an end adjacent to the surface 200 such that when opened, the GAIN door 302 pivots towards the surface 200.

FIG. 2b shows the GAIN door 302 in an open position. In this position, the GAIN door 302 is substantially parallel to the surface 200 and contacts the bottle opener 100.

When the bottle opener 100 as described below is mounted to surface, it provides the advantage of allowing the GAIN door 302 to rotate further into the open position from the closed position. By allowing the GAIN door 302 to rotate further into the open position, improved access is provided to the Galley Insert compartment 304. An additional advantage of the bottle opener 100 as described herein is that the surface against which the GAIN door 302 can rest may be configured such that damage to the GAIN door 302 due to contact with the bottle opener 100 is reduced.

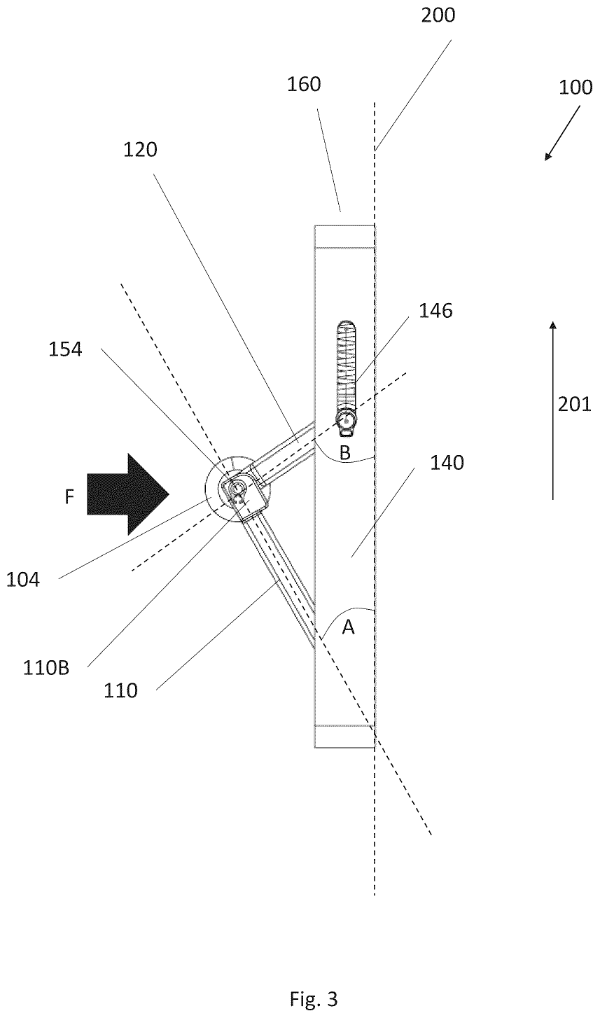

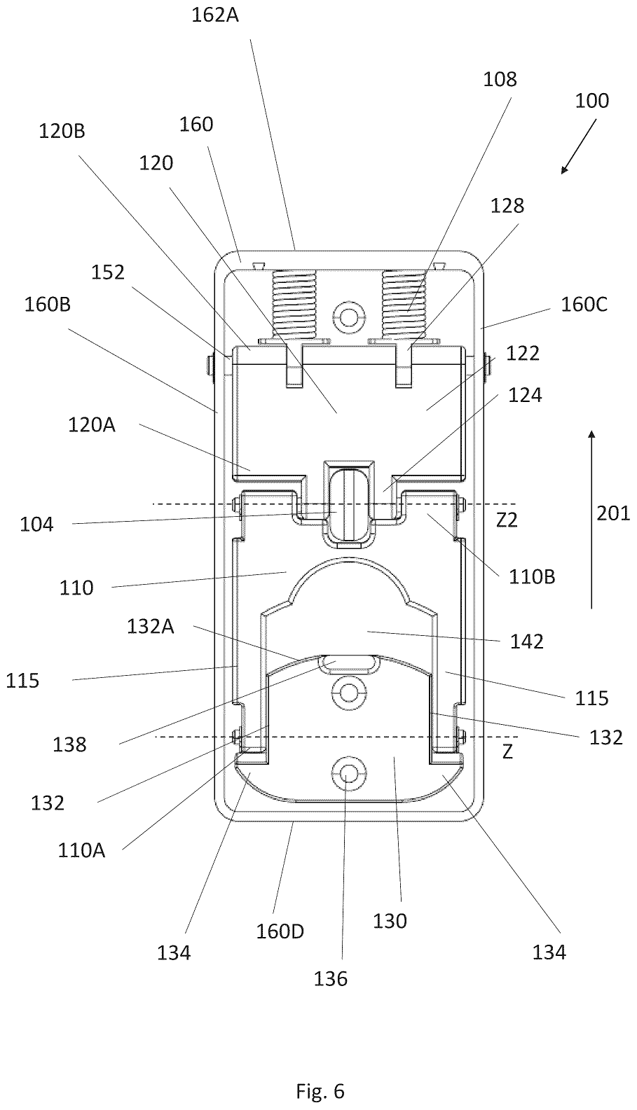

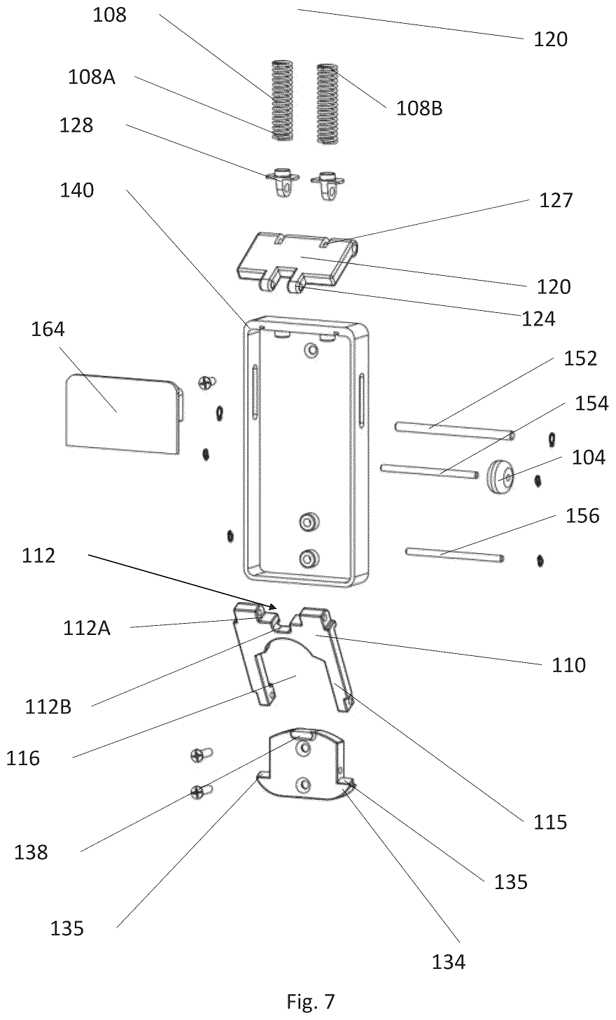

FIGS. 3, 4, 5 and 6 show front and side perspective views of the bottle opener 100 in accordance with an example of the disclosure. FIG. 7 shows an exploded view of the bottle opener 100 in accordance with an example of the disclosure. As seen in FIG. 6, the bottle opener 100 comprises a first member 110 having a first end 110A and a second end 110B. The first end 110A is opposite the second end 110B. The first end 110A is spaced from the second end 110B. The first member 110 is configured to be pivotably mounted adjacent the first end 110A thereof relative to the surface 200. The first member 110 may be configured to pivot about an axis Z fixed in relation to the surface 200.

In some examples, the axis Z may be parallel to the surface 200. The axis Z may be substantially perpendicular to the vertical direction 201. The axis Z may also be parallel to the vertical surface 200. The bottle opener 100 is configured to move between a default use position and a stowed position. The first member 110 is configured to pivot between the default use position (as seen in FIGS. 1, 3 and 4) and the stowed position (as seen in FIGS. 2, 5 and 6).

The first member 110 may be a plate. In other words, the first member 110 may be substantially larger in two dimensions (e.g. x and y dimensions) in comparison to a third dimension (e.g. z dimension). The first member 110 may comprise mounting points at the first end 110A and the second end 110B therein. The mounting points may be through holes configured to receive one or more pins. The first member 110 may be a rigid body and May comprise any suitable material. For example, the first member 110 may be made of plastic, metal, wood, or any other rigid material.

As seen in FIG. 7, the first member 110 may comprise a stepped cut-out 112 at the second end 120B therein. The stepped cut-out 112 may comprise two outer cut-outs 112A and an inner cut-out 112B. The inner cut-out 112B may be between the two outer cut-outs 112A. The outer cut-outs 112A and the inner cut-out 112B may be sections removed from the first member 110. The inner cut-out 112B may extend further into the first member 110 from the second end 110B than the outer cut-outs 112A. Alternatively, the inner cut-outs 112A and the outer cut-out 112B may extend an equal distance into the first member 110 from the second end 110B.

As seen in FIG. 3, an angle A may be formed between the first member 110 and the surface 200. In the default use position, the angle A may be less than 90 degrees and more than 20 degrees, and/or less than 80 degrees, and/or less than 70 degrees, and/or less than 60 degrees, and/or less than 50 degrees, and/or about 45 degrees. Preferably, in the default use position the angle A may be 30 degrees.

Angle A is smaller when the first member 110 is in the stowed position compared to the default use position. In other words, the second end 110B of the first member 110 may be closer to the surface 200 in the stowed position than in the default use position. The first member 110 may extend substantially parallel to the surface 200 in the stowed position. In the stowed position, or when the first member 110 extends substantially parallel to the surface 200, the angle A may be less than 20 degrees, and/or less than 10 degrees, and/or less than 5 degrees, and/or 0 degrees, and/or more than-5 degrees.

By providing a stowed position of the first member 110, the space efficiency of the bottle opener 100 is improved. For example, should the bottle opener 100 in accordance with the disclosure be placed on a wall towards which a galley insert compartment door opens as described above in relation to FIGS. 1b and 2b, the galley insert compartment door will have a greater space to open into and thus can be opened wider (in other words, rotated through a greater angle) as the stowed position of the first member reduces the amount of space the bottle opener requires.

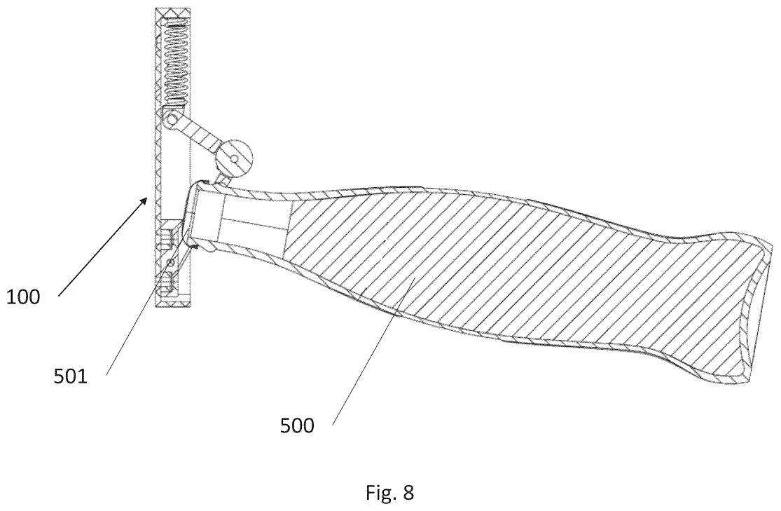

With brief reference to FIG. 8, which shows a perspective view of the bottle opener 100 and a bottle 500 in accordance with an example of the disclosure, the first member 110 further comprises an edge 118. The edge 118 at least partly defines an opening 116 in the first member 110. The opening 116 may extend entirely through the first member 110. The opening 116 is located between the first end 110A and the second end 110B of the first member 110. The opening 116 may be closer to or adjacent the first end 110A of the first member 110. The opening 116 is configured to receive at least a part of the bottle 500. Part of the bottle 500 may be inserted through the opening 116.

The edge 118 is configured to receive and remove a bottle cap 501 from the bottle 500. The edge 118 may be configured to receive and remove the bottle cap 501 from the bottle 500 when the first member 110 is in the default use position. The bottle cap 501 may be inserted through the opening 116. The edge 118 may be disposed between the first and second ends of the first member 110 such that, when the first member 110 is in the default use position, the edge 118 is spaced from the surface 200 such that at least a part of the bottle cap 501 may be received between the edge 118 and the surface 200. In some examples, the edge 118 may be curved such that it forms part of a circle. The edge 118 may be configured to engage a rim of a bottle cap 501. The edge 118 may be curved such that it is configured to conform to part of the bottle cap 501.

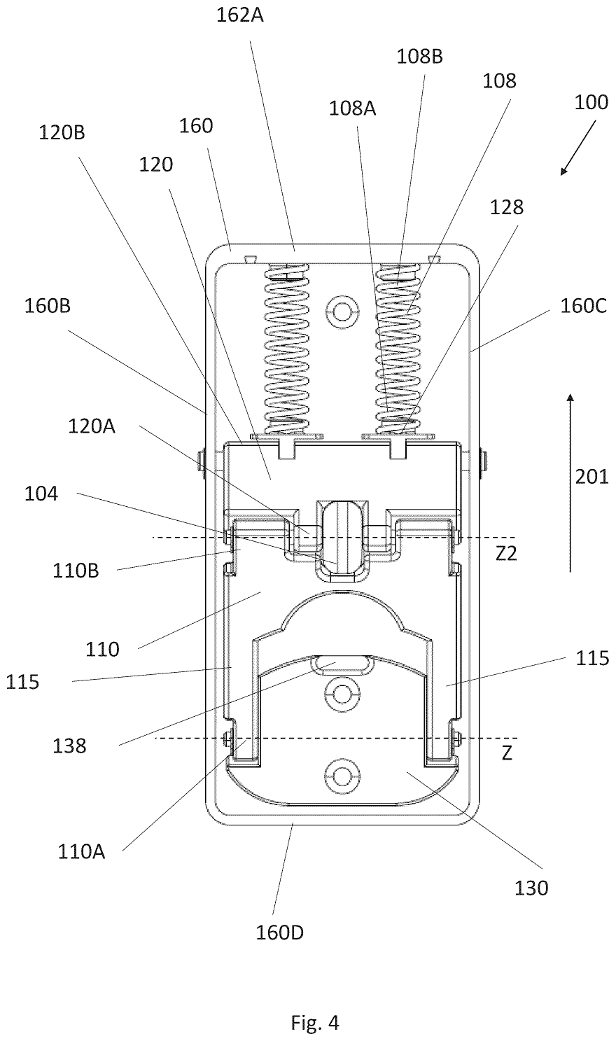

As seen in FIGS. 4 and 6, the first member 110 may comprise one or more legs 115 extending from the first end 110A towards the second end 110B. The legs 115 may further define the opening 116 therebetween. The legs 115 may comprise mounting points configured to receive one or more pins. Thus, the opening 116 may be at least partly defined by the legs 115 and the edge 118. The opening 116 may be configured to receive at least part of the bottle 500. In some examples, the opening 116 may be configured to receive a top of the bottle 500.

Referring once again to FIGS. 3-7, and in particular FIGS. 6 and 7, The bottle opener 100 further comprises a limiting member 120, the limiting member 120 is configured to limit the extent to which the first member 110 can pivot relative to the surface 200 such that the second end 110B of the first member 110 is higher than the first end 110A of the first member 110 in the vertical direction 201 when in the stowed position or when in the default use position.

In some examples, a first part of the limiting member 120 may be fixed relative to the surface 200 and a second part of the limiting member may be attached to the first member 110. In examples, the extent to which the first member 110 is limited to pivot may be dictated by the distance between the first part and the second part of the limiting member 120. In some examples, the limiting member 120 may be flexible. The limiting member 120 may be string.

In some examples, the second part of the limiting member 120 may not be attached to the first member 110. Rather, the first part of the limiting member 120 may be fixed relative to the surface 200 and the second part of the limiting member may be disposed within the area swept by the rotational path of the first member 110. In such examples, the limiting member 120 limits the extent to which the first member 110 can pivot relative to the surface by blocking further rotation beyond a certain point. In other words, in this example the second part of the limiting member 120 is placed such that the first member 110 may pivot towards the second part of the limiting member 120 when the first member 110 pivots away from the surface 200. Further, the second part of the limiting member 120 is configured to receive the first member 110 and the first member is disposed between the second part of the limiting member 120 and the surface 200 at all times.

The limiting member 120 may comprise a first end 120A and a second end 120B. The limiting member 120 may be a plate. In other words, the limiting member 120 may be substantially larger in two dimensions (e.g. x and y dimensions) in comparison to a third dimension (e.g. z dimension). The limiting member 120 may comprise mounting points at the first end 120A and the second end 120B therein. The mounting points may be through holes configured to receive one or more pins. The limiting member 120 may be a rigid body and may comprise any suitable material. For example, the limiting member 120 may be made of plastic, metal, wood, or any other rigid material.

The limiting member 120 may comprise a body 122 having a substantially cuboid shape. At the first end 120A of the limiting member 120, one or more notches 124 may extend from the body 122. The notches 124 may extend parallel to the body 122. The notches 124 may comprise a through hole configured to receive one or more pins. In examples, there may be two notches 124 and the notches 124 may define a gap therebetween. The notches 124 may be configured to be received in the stepped cut-out 112. The notches 124 may be configured to be received in the two outer cut-outs 112A.

With brief reference to FIG. 7, the limiting member 120 may comprise one or more slots 127 at the second end 120B. The one or more slots 127 may comprise removed material from the body 122 of the limiting member 120 from the second end 120B towards the first end 120A therein.

The limiting member 120 may be pivotably connected to the first member 110. In preferred examples, the first end 120A of the limiting member 120 may be pivotably connected to the second end 110B of the first member 110. The first end 120A of the limiting member 120 may be pivotably connected to the second end 110B of the first member 110 by a central pin 154. The central pin 154 may pass through the second end 110B, the two outer cut-outs 112A, and the inner cut-out 112B of the first member 110, and through the one or more notches 124. The limiting member 120 may be configured to be pivotably mounted relative to the surface 200. In preferred examples, the limiting member 120 may be configured to be pivotably mounted adjacent the second end 120B thereof relative to the surface 200 about an axis Z2. The limiting member 120 may be configured to pivot about the central pin 154. The second end 120B of the limiting member 120 may be mounted such that it can translate parallel to the surface 200. In some examples such as the example shown, the limiting member 120 may be mounted such that it is can translate in the vertical direction 201. The axis Z2 translates with the second end 120B of the limiting member 120.

As seen in FIG. 3, a second angle B is formed between the limiting member 120 and the surface 200. The second angle B may be formed between the limiting member 120 and the surface 200 about the second end 120B of the limiting member 120. In some examples, the second angle B may be formed about the second axis Z2. When the first member 110 is in the default use position, the limiting member 120 prevents the first member 110 from rotating further away from the surface 200. In other words, when the first member 110 is in the default use position, the limiting member 120 prevents the angle A from increasing further. In the example shown this is achieved by the limiting member 120 reaching a maximum translation as will be described further below. When the first member 110 is in the default use position, the second angle B may be greater than 20 degrees and/or the second angle may be greater than 40 degrees.

When the first member 110 is in the stowed position, the second angle B may be less than 20 degrees, and/or less than 10 degrees, and/or 0 degrees, and/or greater than-5 degrees. In other words, when the first member 110 is in the stowed position, the limiting member 120 may be substantially parallel with the surface 200 and/or, the limiting member 120, the first member 110 and the surface 200 may all be substantially parallel with each other when the first member 110 is in the stowed position. With particular reference to FIGS. 4 6, and 7, the bottle opener 100 may further comprise a biasing means 108. The biasing means 108 may be configured to bias the first member 110 into the default use position. One end 108A of the biasing means 108 may be mounted to the second end 120B of the limiting member 120 such that the biasing means 108 biases the second end 120B of the limiting member 120 to translate substantially parallel to the surface 200 in a direction towards the first end 110A of the first member 110. In some examples, one end 108A of the biasing means 108 may be mounted to the second end 120B of the limiting member 120 such that the biasing means 108 biases the second end 120B of the limiting member 120 to move downward in the vertical direction 201. By biasing the second end 120B of the limiting member 120 to translate substantially parallel to the surface 200 in a direction towards the first end 110A of the first member 110, the biasing means 108 biases the first member 110 into the default use position. The other end 108B of the biasing means 108 may be fixed relative to the surface 200. The biasing means 108 may be a spring, for example a coil spring, compression spring, conical spring, leaf spring. Alternatively, the biasing means 108 may be an elastically deformable body, for example rubber. Alternatively still, the biasing means 108 may be a hydraulic or pneumatic system. The biasing means 108 may comprise an array of individual biasing means 108. For example, the biasing means 108 may comprise two springs, for example two springs acting in parallel.

The bottle opener 100 may further comprise a bumper 104 located adjacent to and/or mounted to the second end 110B of the first member 110. The bumper 104 may be soft and/or compressible. The bumper 104 may be configured to elastically deform when impacted by another object. The bumper 104 may be primarily made from polymer or rubber. The bumper 104 may be rounded. The bumper 104 may be wheel shaped. The bumper 104 may comprise a mounting point configured to receive the central pin 154. The mounting point may be a through hole. The bumper 104 may be configured to be free to rotate relative to the first member 110, for example about the second end 110B of the first member 110. The bumper 104 may be mounted to the first member 110 by the central pin 154. The bumper 104 may be configured to be free to rotate about the central pin 154. The bumper 104 may be disposed in the gap defined by notches 124. The bumper 104 may be partly disposed in the inner cut-out 112B.

Through being configured to deform elastically and/or being free to rotate relative to the first member 110, should an object impact the bumper the severity of the impact will be reduced and the friction arising during the impact will be reduced. Thus, the use of a bumper 104 as described above in comparison to other components may lead to less structural (dents, cracks etc.) and superficial (paint removal, scratching etc.) damage to an object through a collision.

When the first member 110 is in the default use position, the bumper 104 may be further from the surface 200 than the limiting member 120 and the first member 110 in a direction perpendicular to the surface 200. The bumper 104 thereby provides a soft surface if an object collides with the bottle opener 100. For example, if the bottle opener 100 is mounted to a wall towards which a galley compartment door opens, the bumper 104 is configured to protect the galley compartment door from being damaged in the impact with the bottle opener 100.

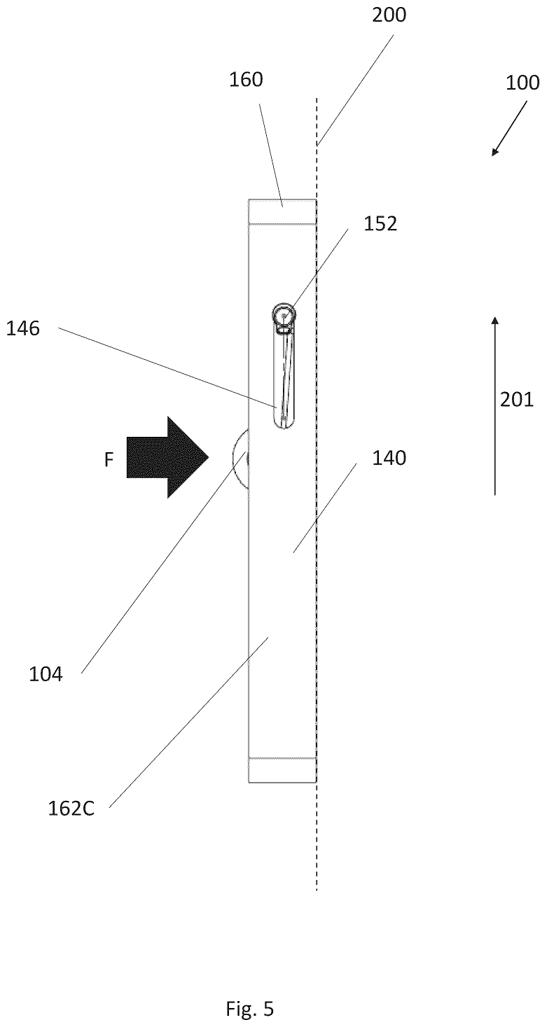

As seen in FIGS. 3 and 5, a force F may be applied to the bottle opener 100 in a direction normal to the surface 200, for example by a galley compartment door. In examples, the force F is applied to the first member 110. In some examples, the force F acts on the first member 110. In some examples, the force F is applied to the limiting member 120. In some examples, the force F is applied to any combination of the bumper 104, the limiting member 120 and the first member 110. Preferably, the force F is applied to the bumper 104. The force F may be sufficient to overcome the bias of the biasing means 108. In response to the force F being applied to the bumper 104, the bottle opener 100 is configured to move into the stowed position. The first member 110 may be configured to pivot towards the surface 200 into the stowed position in response to the force F being applied to the bumper 104, or in response to the force F being applied to the limiting member 120 or the first member 110 at a location adjacent the bumper 104.

The limiting member 120 may be configured to pivot towards the surface 200 in response to the force F being applied to the bumper 104, or in response to the force F being applied to the limiting member 120 or the first member 110 at a location adjacent the bumper 104. The second end 120B of the limiting member 120 may be configured to translate substantially parallel to the surface 200 in a direction away from the first end 110A of the first member 110 in response to the force F being applied to the bumper 104, or in response to the force F being applied to the limiting member 120 or the first member 110 at a location adjacent the bumper 104. In some examples, the second end 120B of the limiting member 120 may be configured to move upwards in the vertical direction 201 in response to the force F being applied to the bumper 104, or in response to the force F being applied to the limiting member 120 or the first member 110 at a location adjacent the bumper 104. The first member 110 can be placed into the stowed position by applying the force F.

Referring once again to FIGS. 3-7, particularly FIG. 6, the bottle opener 100 may further comprise a support structure 160 configured to be mounted to the surface 200. In some embodiments, the support structure 160 may comprise a housing 140 configured to be mounted to the surface 200. The surface 200 may comprise a recess in which the support structure 160 is disposed. Alternatively, the support structure 160 may be disposed on the surface 200. Alternatively still, the support structure 160 may form part of the surface 200.

The first member 110 and/or the limiting member 120 may be pivotably mounted to the support structure 160. The first end 110A of the first member 110 and/or the second end 120B of the limiting member 120 may be mounted to the housing 140. The first end 110A of the first member 110 may be mounted to the housing 140 by a first pin 156. The first pin 156 may be coincident with the axis Z. The first member 110 may be configured to pivot about the first pin 156. The second end 120B of the limiting member 120 may be mounted to the housing 140 by a sliding pin 152. The sliding pin 152 may extend outwardly from one or both sides of the limiting member 120. The sliding pin 152 may be coincident with the second axis Z2. The sliding pin 152 is configured to translate substantially parallel to the surface 200. In some examples, the sliding pin 152 may be configured to translate towards or away from the first end 110A of the first member 110. In some examples, the sliding pin 152 may be configured to translate in the vertical direction 201. The limiting member 120 may be configured to pivot about the sliding pin 152.

The housing 140 may comprise a backplate 142 configured to be mounted to and parallel with the surface 200. The backplate 142 may comprise holes through which fasteners can be inserted in order to mount the housing 140 to the surface 200.

With particular reference to FIG. 7, the housing 140 may further comprise a surround extending from the edge of the backplate 142 away from the surface 200. In the example shown, the surround comprises a first wall 162A, second wall 162B, third wall 162C and fourth wall 162D, each extending from the edge of the backplate 142 away from the surface 200. The first 162, second 162B, third 162C, and fourth 162D walls may extend normal from the surface 200. The first wall 162A may be opposite and spaced from the fourth wall 162D. The first wall 162A and the fourth wall 162D may extend in a direction perpendicular to the vertical direction 201. The first wall 162A may be above the fourth wall 162D in the vertical direction 201. The second wall 162B may be opposite and spaced from the third wall 162C. The second wall 162B and the third wall 162C may extend parallel with the vertical direction 201. The first wall 162A, second wall 162B, third wall 162C, fourth wall 162D and the backplate 142 may define a recess 144. When the first member 110 is in the stowed position, the first member 110 and the limiting member 120 may be disposed within or at least partially within the recess 144. When the first member 110 is in the stowed position, the bumper 104 may also be disposed within or at least partially within the recess 144.

Referring to FIGS. 4 and 6, the support structure 160 may comprise one or more slots 146. The slots 146 may be disposed on the second 162B and third 162C walls. The slots 146 may extend through the second 162B and third 162C walls. The slots 146 may be disposed substantially opposite each other. The slots 146 may extend substantially parallel to the surface 200 and in the vertical direction 201. The slots 146 may extend from above the second end 110B of the first member 110 toward the first wall 162A. The slots 146 may be substantially rectangular or may be substantially rectangular with rounded corners. The slots 146 may comprise a first end 146A and a second end 146B. The first end 146A may be below the second end 146B in the vertical direction 201.

The slots 146 may be configured to receive the sliding pin 152. The sliding pin 152 may be configured to translate substantially parallel to the surface 200 within the slots 146. In some examples, the sliding pin 152 may be configured to translate in the vertical direction 201 within the slots 146. The sliding pin 152 may be configured to translate within the slots 146 between the first end 146A and the second end 146B of the slots 146. In examples, when the first member 110 is in the default use position, the sliding pin 152 is disposed adjacent the first end 146A of the slot 146. When the first member 110 is in the stowed position, the sliding pin 152 may be disposed adjacent the second end 146A of the slot. The sliding pin 152 may be configured to translate substantially parallel to the surface 200 within the slots 146 when the first member 110 is moving between the default use position and the stowed position. When moving from the default use position to the stowed position, the sliding pin 152 translates substantially parallel to the surface 200 towards the first wall 162A.

Referring to FIGS. 6 and 7, the bottle opener 100 may further comprise a rest 130. The rest 130 may protrude substantially normal to and away from the surface 200. In some examples, the rest 130 may protrude from the support structure 160. The rest 130 may be a plate. The rest 130 may comprise a substantially rectangular body which is significantly larger in two dimensions (x and y) than in a third dimension (z). The third dimension may be normal to the surface 200. The rest 130 may comprise two sides 132 that are parallel to the vertical direction 201. The rest 130 may further comprise a top side 132A nearest the first wall 162A and connecting the two sides 132. The top side 132A may be curved. The side 132 may form part of a circle arranged in the plane of the surface 200.

The rest 130 may further comprise one or more holes 136 disposed through the body 131. The holes 136 may be configured to be normal to the surface 200. The holes 136 may be configured to be used in conjunction with a fastener (e.g. a screw) to fix the rest relative to the surface 200.

The first end 110A of the first member 110 may be mounted to the rest 130 via the first pin 156. The rest 130 is configured to be received in the opening 116 when the first member 110 is in the stowed position. The rest 130 may extend from the backplate 142. The legs 115 of the first member 110 may be mounted to sides 132 of the rest 130 via the first pin 156. In some examples, the first pin 156 may be two coincident pins, each used to mount one leg 115 to the rest 130. The sides 132 may be the surfaces substantially perpendicular to the backplate 142.

One or more stops 134 may extend from the sides 132 of the rest 130. Alternatively, the support structure 160 may comprise the stops 134. The stops 134 may be configured to limit the rotation of the first member 110 relative to the surface 200. The stops 134 may prevent the first member 110 from rotating past the default use position. In other words, the default use position of the first member 110 may be, at least in part, defined by the rotational limit provided by the stops 134. The stops 134 may work together with the limiting member 120 to prevent rotation of the first member 110 beyond the default use position.

Each stop 134 may extend from the rest 130 parallel to the surface 200 and substantially perpendicular to the vertical direction 201. Each stop 134 may comprise a top surface 135, the vertical direction 201 being substantially normal to the top surfaces 135. Wedges 135A may extend from the top surfaces 135 configured to engage with the legs 115. The wedges 135A may prevent the first member 110 from rotating past the default use position from the stowed position. The wedges 135A may comprise an angled surface 139 configured to engage with the legs 115. The angled surface 139 may be disposed at an angle equal to angle A from a direction normal to the vertical direction 201.

With particular reference to FIGS. 7 and 8, a bottle cap rest 138 may be provided on the support structure 160. The bottle cap rest 138 may be fixed relative to the surface 200. The bottle cap rest 138 may be configured to be used with the edge 118 to remove a bottle cap 501 from a bottle 500. The bottle cap rest 138 may be provided on the rest 130. Alternatively, the bottle cap rest may be provided on the backplate 142. Alternatively still, the bottle cap rest 138 may be an indentation in the rest 130. The bottle cap rest 138 may be configured to receive the bottle cap 501 and allow the bottle 500 to be pivoted thereon such that a rim of the bottle cap 501 is brought into contact with the edge 118. Upon further rotation, the edge 118 is configured to remove the bottle cap 501 from the bottle.

The bottle cap rest 138 may extend from the rest 130 in a direction normal to the surface 200. The bottle cap rest 138 may comprise an angled surface configured to receive the bottle cap 501. The angled surface may be angled relative to the vertical direction 201. The angled surface may be angled between 20 and 50 degrees from the vertical direction 201.

Referring once again to FIGS. 4 and 6, the biasing means 108 may be disposed between the support structure 160 and the limiting member 120. The biasing means 108 may be disposed between the first wall 162A of the housing 140 and the limiting member 120. The biasing means 108 may be fixed to the first wall 162A of the housing 140. The first wall 162A of the housing 140 may comprise a seat configured to receive the biasing means 108. The biasing means 108 may be a spring under constant compression disposed between the limiting member 120 and the first wall 162 of the housing 140.

The limiting member 120 may comprise spring rests 128 configured to receive the biasing means 108. The spring rests 128 may be pivotably mounted to the second end 120B of the limiting member 120. The spring rests 128 may be mounted to the limiting member 120 via the sliding pin. The spring rests 128 may be configured to move with the second end 120B of the limiting member 120.

Referring to FIG. 7, the support structure 160 may further comprise a cover 164. The cover 164 may be configured to be received over the first wall to partly enclose the recess 144. The biasing means 108 may be contained within the part of the recess 144 enclosed by the cover 164. The cover 164 may be attached to the housing 140 by a snap fit or may be formed integrally with the housing 140. The cover 164 may be configured to protect the biasing means 108 from accidental impact.

In this disclosure, “substantially perpendicular”, “substantially normal”, “substantially parallel” and another other angular relationships described as “substantially . . . ” shall be taken to mean that two lines/planes are within the range of +20 degrees and −20 degrees of the exact value e.g. “substantially parallel” is taken to mean that two lines or planes are within the range of +20 degrees and −20 degrees of being parallel to one another.

Although the present disclosure has been described with reference to various examples, it will be understood by those skilled in the art that various changes in form and detail may be made without departing from the scope of the disclosure as set forth in the accompanying claims.

1. A bottle opener for mounting to a surface, comprising:
a first member having a first end and a second end opposite the first end, wherein the first member is configured to be pivotably mounted adjacent the first end thereof so as to be pivotable relative to the surface, the bottle opener having a default use position in which the first member extends outwardly at an angle (A) to the surface and a stowed position in which the first member extends substantially parallel to the surface;
a limiting member configured to limit the extent to which the first member can pivot relative to the surface; and
an edge formed in the first member and configured to receive and remove a bottle cap from a bottle.

2. The bottle opener of claim 1, wherein the bottle opener comprises a biasing means that biases the first member into the default use position.

3. The bottle opener of claim 2, wherein the bottle opener is configured to move into the stowed position in response to a force (F) acting against the biasing means being applied thereto.

4. The bottle opener of claim 1, wherein the limiting member is pivotably connected to the first member.

5. The bottle opener of claim 1, wherein the limiting member is configured to be pivotably mounted relative to the surface.

6. The bottle opener of claim 5, wherein the limiting member is configured to be mounted relative to the surface such that it can translate substantially parallel to the surface.

7. The bottle opener of claim 1, further comprising a bumper mounted adjacent to the second end of the first member.

8. The bottle opener of claim 7, wherein in response to a force (F) being applied to the bottle opener in a direction towards and substantially perpendicular to the surface, the first member is configured to pivot towards the surface, the limiting member is configured to pivot towards the surface, and the second end of the limiting member is configured to translate substantially parallel to the surface.

9. The bottle opener of claim 1, further comprising a support structure configured to be mounted to the surface.

10. The bottle opener of claim 9, wherein the first member and/or the limiting member are pivotably mounted to the support structure.

11. The bottle opener of claim 10, wherein the support structure comprises one or more slots configured to receive a sliding pin, wherein the limiting member is connected to the support structure by the sliding pin, wherein the sliding pin is configured to be disposed in the one or more slots such that the sliding pin can translate substantially parallel to the surface.

12. The bottle opener of claim 9, wherein the support structure comprises a stop configured to limit the extent to which the first member can pivot relative to the surface.

13. The bottle opener of claim 1, further comprising a bottle cap rest that is fixed relative to the surface, wherein the bottle cap rest is configured to be used with the edge to remove the bottle cap from the bottle.

14. The bottle opener of claim 13, wherein the first member comprises one or more legs extending from the first end towards the second end, wherein an opening is defined by the legs and by the edge, wherein the opening is configured to receive at least part of the bottle.

15. A bottle opener, comprising:
a first member having a first end, wherein the first member is configured to be mounted to a surface adjacent the first end thereof to extend outwardly at an angle (A) from the surface, the first member comprising:
an edge configured to receive and remove a bottle cap from a bottle;
a second end, opposite the first end; and
a bumper adjacent to the second end of the first member, wherein the bumper extends further from the surface in a direction normal to the surface than the first member, wherein the bumper is free to rotate relative to the first member.
